(19) United States
(12) Patent Application Publication
(10) Pub. No.: US 2009/0294497 A1
(43) Pub. Date: Dec. 3, 2009

(54) Combination Step and Storage Unit for Pickup Truck

(75) Inventor: Petar Todorovic, Etobicoke (CA)

Correspondence Address: LANG MICHENER, BROOKFIELD PLACE, P.O. BOX 747, SUITE 2500, 181 BAY STREET, TORONTO, ON, M5J 2T7, CA

(73) Assignee: APPOLO MACHINE LTD., Mississauga, ON (CA)

(21) Appl. No.: 12/236,776

(22) Filed: Sep. 24, 2008

(30) Foreign Application Priority Data
May 29, 2008 (CA) 2632467

(51) Int. Cl. B60R 9/02

(52) U.S. Cl. 224/402; 224/486; 224/538; 224/539; 224/555; 296/37.6

(57) ABSTRACT

The invention comprises a combination storage unit and step for a pickup truck, comprising: a) a body, containing an interior cavity for storage of items; b) one or more doors providing access to the interior of the storage body; c) one or more step assemblies mounted to the storage body and located adjacent to one or more of the doors; d) one or more brackets to secure the storage body to the undercarriage body mounts of the pickup truck, wherein the storage unit is mounted in a location between the front axle and rear axle of the pickup truck on one of the driver side and passenger side.

### FIELD OF THE INVENTION

The present invention relates to the field of motor vehicle accessories. In particular, it relates to combination step and storage unit for use with a pickup truck.

### BACKGROUND OF THE INVENTION

Pickups trucks are in widespread used in North America, both as commercial and as recreational vehicles. The advantage provided to the user of a pickup truck is the increased storage ability provided by the pickup bed, while maintaining size and performance characteristics similar to a passenger car. An associated disadvantage is the exposure of the bed to the elements, and the need to use additional equipment (tie-downs, bungie cords, ropes) to secure cargo within the bed.

Past efforts to improve the storage characteristics of pickup trucks have focused on modification to either the interior cab of the truck, or the bed of the truck, generally to provide compartments for segregation and protection of stored items. An overlooked area is the space between the front and rear axles, often provided with a step or railing to assist users in climbing in to the cab of the truck.

There is a need for improved storage units associated with pickup trucks. Ideally, such a storage unit can replace an existing step or rail and provide additional storage while continuing to be used as a step by the user.

It is an object of this invention to partially or completely fulfill one or more of the above-mentioned needs.

### SUMMARY OF THE INVENTION

The invention comprises a combination storage unit and step for a vehicle, preferably a pickup truck, comprising: a) a body, containing an interior cavity for storage of items; b) one or more doors providing access to the interior of the storage body; c) one or more step assemblies mounted to the storage body and located adjacent to one or more of the doors; d) one or more brackets to secure the storage body to the undercarriage body mounts of the pickup truck, wherein the storage unit is mounted in a location between the front axle and rear axle of the pickup truck on one of the driver side and passenger side.

The body may further include dividers within the body between the doors such that each door opens in to a separate storage compartment. The body may additionally include a hinged section, preferably extending the length of the body, which can be open to allow access to the interior of the body in addition to the doors.

Alternatively, the step assemblies can be omitted, leaving the body accessible by the doors and the full interior of the body available for storage. The top of the body may also be reinforced and/or treaded for use as a step.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a perspective view of a combination step and storage unit according to an embodiment of the present invention;

FIG. 2 is an exploded view of the combination step and storage unit of FIG. 1;

FIG. 3 is a top view of the combination step and storage unit of FIG. 1;

FIG. 4 is a front view of the combination step and storage unit of FIG. 1;

FIG. 5 is a cross-section along line B-B of FIG. 4;

FIGS. 6A-6E are front views of various embodiments of the present invention;

FIG. 7 is a perspective view of a pickup truck with a mounted combination step and storage unit according to the present invention, and

FIG. 8 is a perspective view of an alternative embodiment of the present invention.

### DETAILED DESCRIPTION OF THE PREFERRED EMBODIMENTS

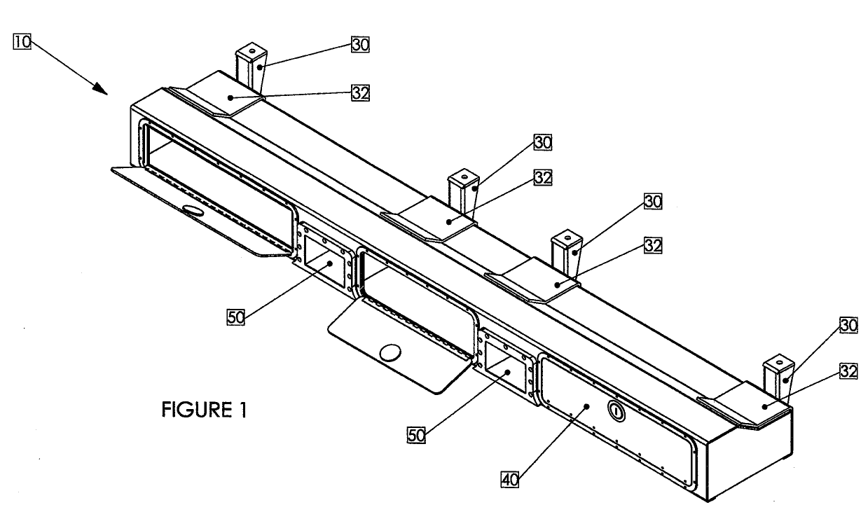

The inventive product presented herein comprises a combination step and storage unit 10 for a vehicle, such as a pickup truck, as shown in FIG. 1, which is attached to the underbody chassis of the vehicle. The storage unit is mounted at a location between the front and rear axles on either or both the driver and passenger side as shown on a pickup truck 100 in FIG. 7.

The combination step and storage unit 10 is primarily comprised of a body 20, which is hollow to allow for storage inside the body 20, one or more doors 40 to allow access to the interior of the body 20, and one or more brackets 30 that secure the body 20 to the chassis of the pickup truck. The provided storage area is ideal for smaller items that are required by the user immediately upon exiting the truck, such as tools, blueprints, personal luggage, and similar items. A potential application is for use by fire and emergency services vehicles, as the storage unit 10 can contain fire extinguishers, oxygen tanks, fire axes, and similar-sized equipment in a location that is accessible immediately upon the driver and/or passengers exiting the truck.

Step assemblies 50 are additionally mounted inside the body 20 to allow passengers to use the step assembly 50 to climb into the cab of the pickup truck. The steps are preferably located between the doors 40, however, the exact location will be determined by the overall dimensions of the body relative to the position of the cab of the truck.

As shown in FIG. 2, the body 20 is formed from a base plate 22, a pair of end covers 24, and a housing 26. The housing 26 is shaped and dimensioned to correspond to the shape and appearance of the pickup truck, and will typically have a larger front section which extends outward from the frame of the truck, and a smaller rear section which extends under the frame of the truck.

The body 20 as shown in FIG. 2 is formed from separate elements, however, some or all of these elements may be formed as a unitary body depending of the choice of materials and manufacturing method. The body 20 can be formed from ABS plastic, extruded aluminum, steel, carbon fiber, or any other material known and used in the automotive body parts industry.

To secure the body 20 to the truck, brackets 30 are used. Preferably, although not necessary depending on the materials used and the design of the body, an additional stiffening plate 32 is located between each bracket 30 and body 20 to reinforce the body 20 at the mounting point. The position and number of the brackets 30 is determined by the body mount position of the pickup truck, based on manufacturer, model type and model year. The brackets 30 are bolted or otherwise secured to the frame of the truck, thereby securing the body to the truck. As shown in FIG. 2, there are four brackets, one at either end, and two on either side of the midpoint. Other truck types will require different positioning, for example, the extended-cab version of the Chevrolet Silverado only requires three brackets, with one at either end and one approximately at the midpoint. As a result, the step assemblies 50 should be positioned so as to assist persons entering the vehicle cab, as shown in FIG. 7.

Access to the interior of body 20 for storage is provided by one or more doors 40. The number, size and position of the doors can be varied based on the overall size of the body and the aesthetic preference of the user. Each door 40 is coupled to the body 20 by a door frame 42. The door panel 44 is coupled to the door frame 42 by a hinge 46, preferably a piano-style hinge to maximize door clearance and available space. The door panel 44 is further provided with a clasp or lock 62 to close and secure the door panel within the door frame 42. Optionally, a gasket assembly 48 can be provided as part of the door frame to protect against fluid and debris from entering into the body 20 through the door 40 during normal use of the truck.

As shown in FIG. 2, the door frames 42 are secured to the body 20 by a set of screws, however, alternative methods, such as welding, bolting and/or adhesives, can be used.

In between the doors 40, a step assembly 50 is mounted to the body 20. The step assembly 50 is dimensioned to allow a user to place their foot inside the step assembly 50 for assistance in climbing in to the cab of the truck. The step assembly 50 can be approximately a half-foot size, as shown, to provide a step up without sacrificing storage space within the body 20. The interior of the step assembly 50 may be crenellated or treaded to provide an improved gripping surface for the user.

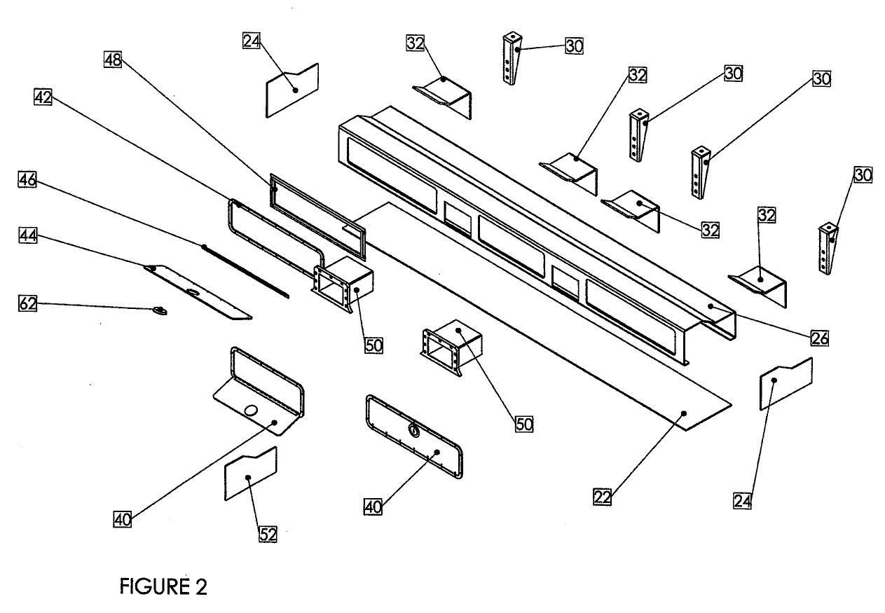

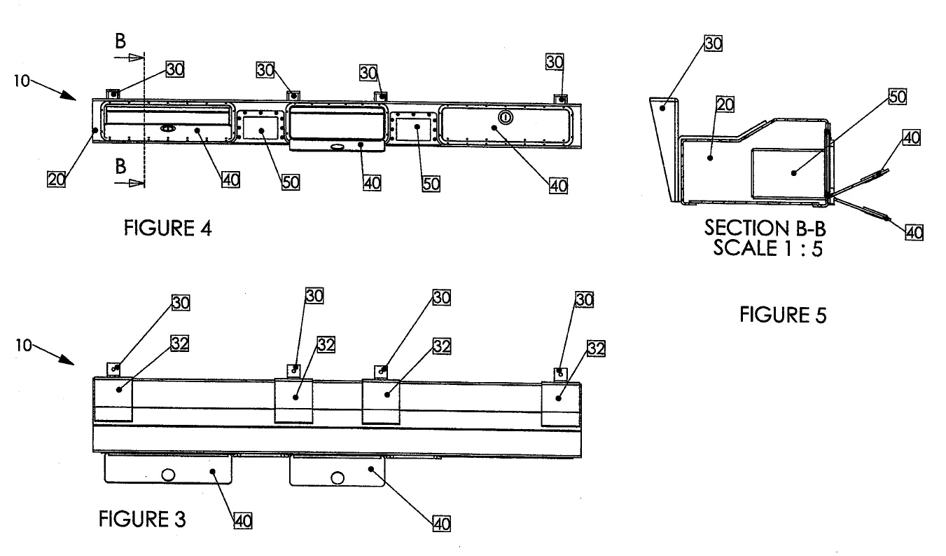

In operation, the user can access the interior of the body 20 through opening the doors 40 as best shown in FIGS. 3 and 4. As seen in the cross section in FIG. 5, step assembly 50 partially extends into the body 20, allow for items to be stored in the space behind the step assembly 50, increasing the overall storage capacity available.

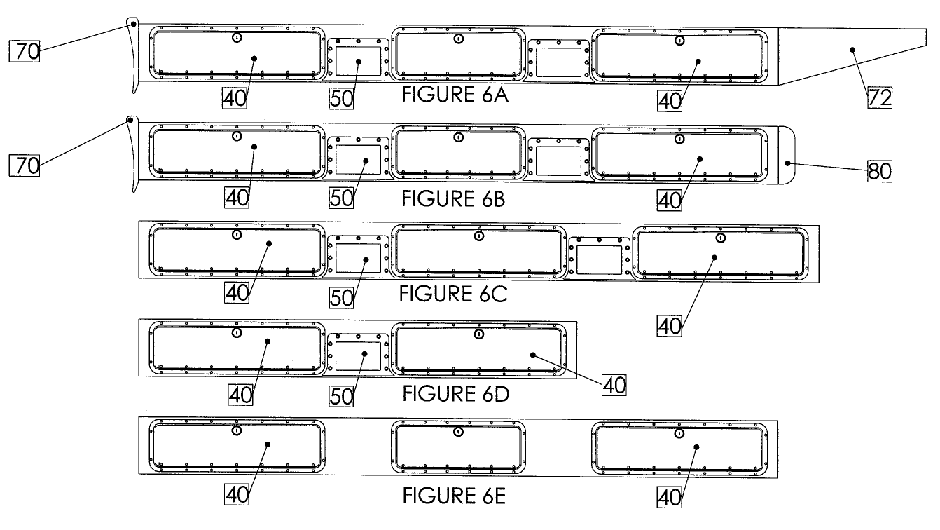

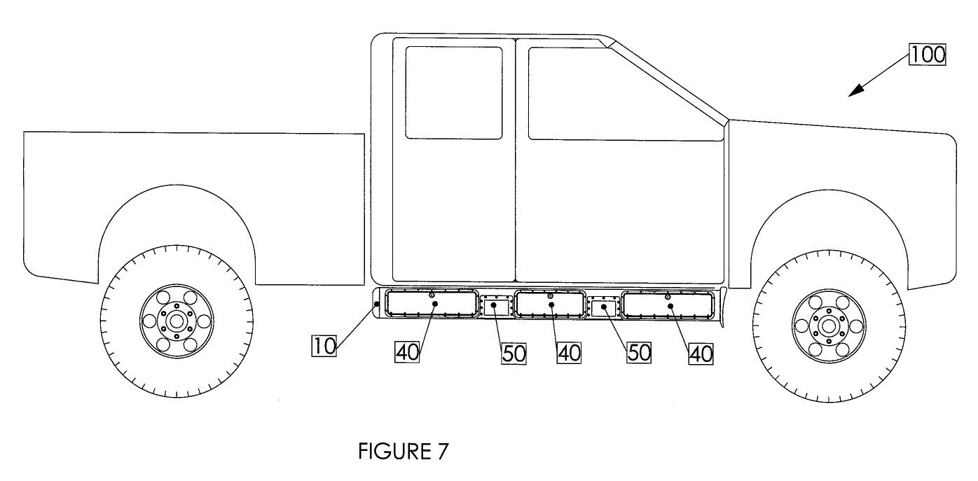

Also, the number of doors 40 and step assemblies 50, as well as the overall shape of the body 20 can be modified to reflect the styling of the pickup truck and the available space between the axles. Several alternative embodiments are shown in FIGS. 6A-6E, including a rear body extension 72 (FIG. 6A), an attached front mudflap 70 (FIGS. 6A and 6B), a rear light 80 (FIG. 6B), a three-door, two-step embodiment as described above herein (FIG. 6C), a two-door, one-step short-body embodiment (FIG. 6D), and a 3-door embodiment with no steps (FIG. 6E). If the step assemblies 50 are omitted, as an alternative, the top surface of the body 20 can be treaded and/or reinforced for use as a step. Other functional and/or aesthetic features, such as running lights around the perimeter of the body and/or doors, can also be added as desired.

While the interior of the body 20 is shown as a single cavity, additional features can be incorporated to provide enhanced support for stowed items. For example, dividers 52, as shown in FIG. 2, can be placed between the doors 40 to separate the interior of the body 20 into multiple discrete storage areas. As another example, hooks or loops can be provided inside the body to enable the use of bungie cords or tie-downs to secure loose items inside the body 20.

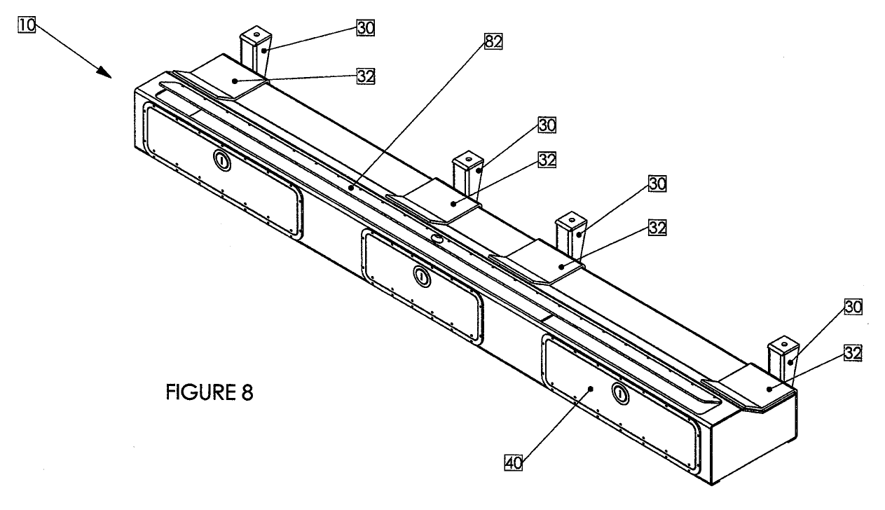

As an alternative embodiment, the doors 40 can be replaced by making the front face of the body 20 c hinged, to allow the entire front to fold down to enable the storage of items which are longer than the space provided by the doors 40. As another alternative variant shown in FIG. 8. a part 82 of the top section of the body 20 can be hinged to open up the top surface to enable storage of long items (tent poles, fishing rods, hockey sticks, etc.).

While the above combination step and storage unit has been presented in the context of pickup trucks the method is equally applicable to similar vehicles such as jeeps, Hummers, sport-utility vehicles (SUV) and other “crossover” vehicles and more generally to any twin axle passenger vehicle.

This concludes the description of a presently preferred embodiment of the invention. The foregoing description has been presented for the purpose of illustration and is not intended to be exhaustive or to limit the invention to the precise form disclosed. It is intended the scope of the invention be limited not by this description but by the claims that follow.

What is claimed is:

1. A combination storage unit and step for a vehicle, comprising:
a) a body, containing an interior cavity for storage of items;
b) one or more doors providing access to the interior of the body;
c) one or more step assemblies mounted to the body and located adjacent to one or more of the doors;
d) one or more brackets to secure the body to one or more undercarriage body mounts of the vehicle,
wherein the storage unit is mounted in a location between the front axle and rear axle of the vehicle on one of the driver side and passenger side of the vehicle.

2. The storage unit of claim 1, wherein said brackets further include reinforcing plates located between each of the brackets and the body.

3. The storage unit of claim 1, wherein said body further includes dividers located between the doors such the each said door opens into a separate storage compartment within said body.

4. The storage unit of claim 1, wherein each door further includes a sealing gasket around the perimeter of the door to inhibit passage of fluid and debris into the body during normal operation of the vehicle when the door is closed.

5. The storage unit of claim 1, wherein the body is reinforced such that the top surface of the body can be used as a step.

6. The storage unit of claim 1, wherein the body is formed as a unitary body from extruded aluminum.

7. The storage unit of claim 1, wherein the body is formed from separate components welded together.

8. The storage unit of claim 1, further including a hinged section in the top of the body, operative to open to provide access to the interior of the body.

9. The storage unit of claim 8, wherein said hinged section extends substantially the full length of the body.

10. The storage unit of claim 1, wherein the vehicle is a pickup truck.

11. A combination storage unit and step for a vehicle, comprising:
a) a body, containing an interior cavity for storage of items;
b) one or more doors providing access to the interior of the body;
c) one or more brackets to secure the body to the undercarriage body mounts of the vehicle,
wherein the storage unit is mounted in a location between the front axle and rear axle of the vehicle on one of the driver side and passenger side.

12. The storage unit of claim 11, wherein said brackets further include reinforcing plates located between each of the brackets and the body.

13. The storage unit of claim 11, wherein said body further includes dividers located between the doors such the each said door opens into a separate storage compartment within said body.

14. The storage unit of claim 11, wherein each door further includes a sealing gasket around the perimeter of the door to inhibit passage of fluid and debris into the body during normal operation of the vehicle when the door is closed.

15. The storage unit of claim 11, wherein the body is reinforced such that the top surface of the body can be used as a step.

16. The storage unit of claim 11, wherein the body is formed as a unitary body from extruded aluminum.

17. The storage unit of claim 11, wherein the body is formed from separate components welded together.

18. The storage unit of claim 11, further including a hinged section in the top of the body, operative to open to provide access to the interior of the body.

19. The storage unit of claim 18, wherein said hinged section extends substantially the full length of the body.

20. The storage unit of claim 11, wherein said vehicle is a pickup truck.
